(19) United States
(12) Patent Application Publication
(10) Pub. No.: US 2022/0255940 A1
(43) Pub. Date: Aug. 11, 2022

(54) SYSTEM OF CONTROLLING ACCESS OF USER TO RESOURCE AND METHOD THEREOF

(71) Applicant: Hitachi, Ltd., Tokyo (JP)

(72) Inventors: Toshiyuki Aritsuka, Tokyo (JP); Masakuni Agetsuma, Tokyo (JP); Takahiro Yamamoto, Tokyo (JP); Tatsuya Hirai, Tokyo (JP)

(73) Assignee: Hitachi, Ltd., Tokyo (JP)

(21) Appl. No.: 17/470,067

(22) Filed: Sep. 9, 2021

(30) Foreign Application Priority Data
Feb. 10, 2021 (JP) 2021-019751

(51) Int. Cl. H04L 29/06; G06K 9/00

(52) U.S. Cl. CPC H04L 63/101; H04L 63/20; G06K 9/00369; H04L 63/102; H04L 63/0861

(57) ABSTRACT

A system that controls access to a resource by a user stores policy information for determining a condition with respect to an operation of the resource. The system acquires a first access request that shows a predetermined operation to a first resource by the user from a user terminal. The system acquires user state information that shows a current state of the user from the user terminal. The system determines a condition in case of access by the user based on the user state information. The system determines whether to authorize the first access request based on the policy information and the condition in case of access.

### CLAIM OF PRIORITY

The present application claims priority from Japanese patent application JP 2021-019751 filed on Feb. 10, 2021, the content of which is hereby incorporated by reference into this application.

### BACKGROUND OF THE INVENTION

### 1. Field of the Invention

The present invention relates to access control for a resource.

### 2. Description of Related Art

As a document in the related art that discloses a background art of the present disclosure, there is US-A-2019/0361726. US-A-2019/0361726 discloses access control for resources using virtualization technology. Specifically, a computer system having a plurality of resources used for a source program includes resource management information for storing information in which resources and resource groups are associated, and resource group management information for storing information in which users who can use the resource groups and source programs are associated. When a request of designating a resource corresponding to a user who uses a source program is received from the source program, a control unit uses the resource group management information and the resource management information to determine whether access to the resource according to the request can be performed.

A security function of limiting access to a resource to an authorized user can be based on a role of a user and an attribute. A user who is engaged in a plurality of tasks and works is assigned a plurality of roles or attributes for dividing resource access permissions. However, for example, when a user is in charge of a maintenance task and performs different works according to situations, this access control function cannot determine whether the user accesses the resources as a worker of which work at a certain point in time, and thus a security risk increases.

### SUMMARY OF THE INVENTION

According to a representative example of the present disclosure, a system that controls access to a resource by a user includes one or more processors; and one or more storage devices that store policy information for determining a condition with respect to an operation of the resource, in which the one or more processors acquire a first access request that shows a predetermined operation to a first resource by the user from a user terminal, acquire user state information that shows a current state of the user from the user terminal, determine a condition in case of access by the user based on the user state information, and determine whether to authorize the first access request based on the policy information and the condition in case of access.

According to a representative example of the present invention, a security risk in resource access can be reduced. Objects, configurations, and effects other than those described above are clarified by the description of the following examples.

### BRIEF DESCRIPTION OF THE DRAWINGS

FIG. 1 shows a configuration example of a computer system according to an example of the present specification;

FIG. 2 schematically shows a logical configuration example of a computer system;

FIG. 3 shows an example of a resource access command issued by a command issuance unit of a user terminal;

FIG. 4 shows an example of an authentication type that can be used by a user authentication unit for user authentication;

FIG. 5 shows an example of information acquired by an access state acquisition unit;

FIG. 6 shows examples of a state acquisition device that can be used for determining a user state, acquired data, and a method of determining a user state from the acquired data;

FIG. 7 shows an example of an access condition determination method;

FIG. 8 shows an example of a policy using a resource access condition of a user;

FIG. 9 shows an example of a processing flow of a resource access authentication and an authorization system based on a user access condition;

FIG. 10 shows a configuration example showing an authentication and authorization system that authorizes a resource operation parameter; and

FIG. 11 shows an example of a policy that determines authorization of the resource operation parameter.

### DESCRIPTION OF EMBODIMENTS

Hereinafter, embodiments of the present invention are described with reference to the drawings. The following description and drawings are examples for describing the present invention, and are appropriately omitted and simplified for clarification of the description. The present invention is also implemented in various other forms. Each component may be singular or plural, unless specified otherwise.

Further, the examples described below do not limit the invention according to the claims, and not all combinations of elements described in the examples are essential for the means for solving the invention.

In the following description, various kinds of information may be described by expressions such as “table”, “list”, and “queue”, but various kinds of information may be expressed by a data structure other than these, and “xxx table”, “xxx list”, “xxx queue”, and the like may be referred to as “xxx information” in order to show that the information does not depend on the data structure. In the following description, when the identification information is described, expressions such as “identification information”, “identifier”, “name”, “ID”, and “number” are used, but these can be replaced with each other.

In the following description, if there are a plurality of components having the same or similar functions, the components are basically given the same reference numerals, but even if the functions are the same, means for realizing the functions may be different. Further, the embodiment of the present invention described below may be implemented by software running on a general-purpose computer or may be implemented by dedicated hardware or a combination of software and hardware.

Further, in the following description, the process may be described with “program” as a subject, but the program is executed by a processor (for example, Central Processing Unit: CPU) to perform a specified process by appropriately using a storage resource (for example, memory), interface device (communication port), and/or the like. Therefore, the description can be made by using the processor as the subject of process.

The process described with the program as a subject may be a process performed by a computer with a processor (for example, a calculation host and a storage device). In the following description, the expression “controller” may refer to a processor or a hardware circuit that performs a portion or all of processes performed by the processor.

The program may be installed on each computer from a program source (for example, a program distribution server or a computer-readable storage medium). In this case, a program distribution server includes a CPU and storage resources, the storage resource further stores a distribution program and a program to be distributed, and the CPU executes the distribution program, so that the CPU of the program distribution server may distribute the program to be distributed to other computers.

In the following description, two or more programs may be implemented as one program, and one program may be implemented as two or more programs.

In the following description, the storage drive or simply the drive means a physical storage device, and typically may be a non-volatile storage device (for example, an auxiliary storage device). The drive may be, for example, a Hard Disk Drive (HDD) or a Solid State Drive (SSD). The storage system may include different types of drives in a mixed manner.

Hereinafter, the resource access control according to the embodiment of the present specification is described. A security function that limits access to storage resources and the like to authorized users is required. In access control based on user roles and attributes, a plurality of roles and attribute information are assigned to users engaged in a plurality of tasks or works in order to classify resource access permissions. However, for example, when a user is in charge of maintenance work and performs different work depending on the situation, this access control technology cannot determine whether the user accesses the resources as a worker of which work at a certain point in time, and thus a security risk increases.

According to an embodiment of the present specification, an access condition is determined based on the access state of the user who requests access indicating an operation to the resource. The denial of the access request is determined by comparing the conditions determined for the access request with the access condition. Accordingly, the security risk in the resource access can be reduced. In the following, the example of the access control to the storage resource is described. The features of the present disclosure can be applied to resource access control to a system different from the storage system.

### EXAMPLE 1

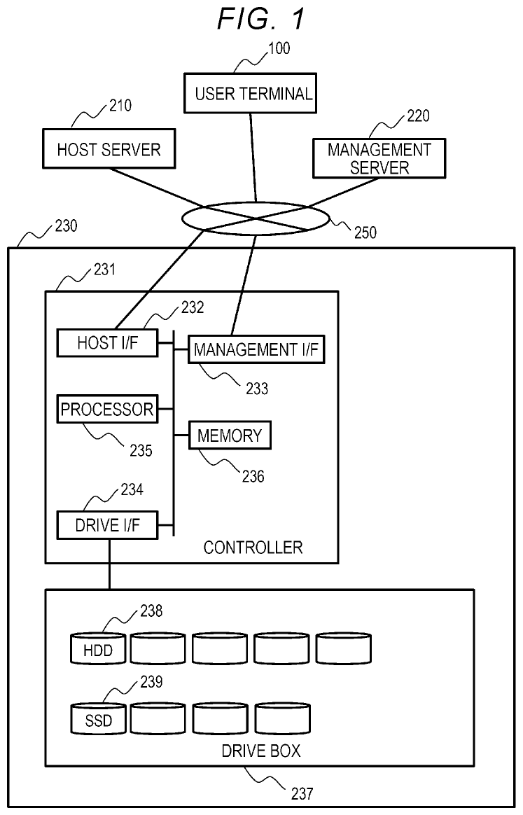

FIG. 1 shows a configuration example of a computer system according to an example of the present specification. The computer system includes a user terminal 100, a host server 210, a management server 220, and a storage system 230. These can perform communication via a network 250. The numbers of respective components are freely set. The user terminal 100 may include a function of the host server 210 or the management server 220.

The method of the network 250 may be, for example, Local Area Network (LAN) or Storage Area Network (SAN). The host server 210 and the management server 220 may access the storage system 230 via different networks, and the user terminal 100 may access the host server 210 or the management server 220 via a network different from the network 250.

The user terminal 100 is a device that can enable the user to access the computer system. The user terminal 100 can have, for example, a general computer configuration, and includes one or more processors, one or more storage devices, one or more network interfaces, and one or more input and output interfaces. The user terminal 100 may include hardware dedicated to a specific process.

The host server 210 is a host machine operated by a user application or the like. The host server 210 can have, for example, a general computer configuration, and includes one or more processors, one or more storage devices, and one or more interfaces. The host server 210 may include hardware dedicated to a specific process.

The host server 210 can execute various software programs, for example, executes a database or a Web service, and read or write data generated by the database or the Web service from and to the storage system 230 via the network 250. The host server 210 may execute a resource utilization application described below.

The management server 220 manages the storage system 230. The management server 220 can have, for example, a general computer configuration, and includes one or more processors, one or more storage devices, and one or more interfaces. The management server 220 may include hardware dedicated to a specific process. The management server 220 may execute a software program that manages an authentication and authorization system described below.

The computer system includes the authentication and authorization system described below. The storage system 230 includes a controller 231 and a drive box 237. The controller 231 includes a host interface 232, a management interface 233, a drive interface 234, a processor 235, and a memory 236. The numbers of components are freely set.

The host interface 232 is an interface device for communication with the host server 210. The management interface 233 is an interface device for communication with the management server 220. The drive interface 234 is an interface device for communication with the drive box 237.

The drive box 237 contains one or more nonvolatile or volatile storage drives that store various kinds of data used by the application program of the host server 210. The drive box 237 is connected to the drive interface 234 of the controller 231. In the configuration example of FIG. 1, the drive box 237 includes a plurality of hard disk drive (HDD) 238 and a plurality of solid state drives (SSD) 239. The plurality of storage drives 238 and 239 may configure a group of Redundant Arrays of Independent Disks (RAID) for data redundancy.

The controller 231 controls the storage system 230. The controller 231 provides the volume for storing data of the host server 210 to the host server 210. The controller 231 assigns physical storage areas of the storage drives 238 and 239 to the volume and stores data in the storage drives 238 and 239.

The controller 231 provides a function as a storage to the host server 210. The processor 235 instructs to transmit data stored in the corresponding drive box 237 in response to a read command or a write command from the host server 210. The memory 236 of the controller 231 is configured with, for example, a semiconductor memory such as a Synchronous Dynamic Random Access Memory (SDRAM). The memory may be configured with a volatile memory and a nonvolatile memory in combination.

The processor 235 executes processes for the control of the storage system 230 and communication with the host server 210, the management server 220, and the drive box 237. The memory 236 stores programs for control or communication and various kinds of data as the main storage of the processor 235. The memory 236 stores software programs that embody the authentication and authorization system described below. The memory 236 is also used as a disk cache (cache memory) of the controller 231. The processor 235 embodies a predetermined function that executes a program including an instruction code stored in the memory 236.

A plurality of controllers may be installed for redundancy. The plurality of controllers perform communication via a network in the storage system 230. The controller duplicates the write data, shares the metadata, and the like via the network. Even if one controller is blocked due to maintenance or failure, the storage process can be continued by the other controller.

The computer system may include other than those shown here. For example, network devices such as switches and routers may be connected between the computer system and the network. The computer system may be configured to be connected to the storage service on a public cloud via an external network.

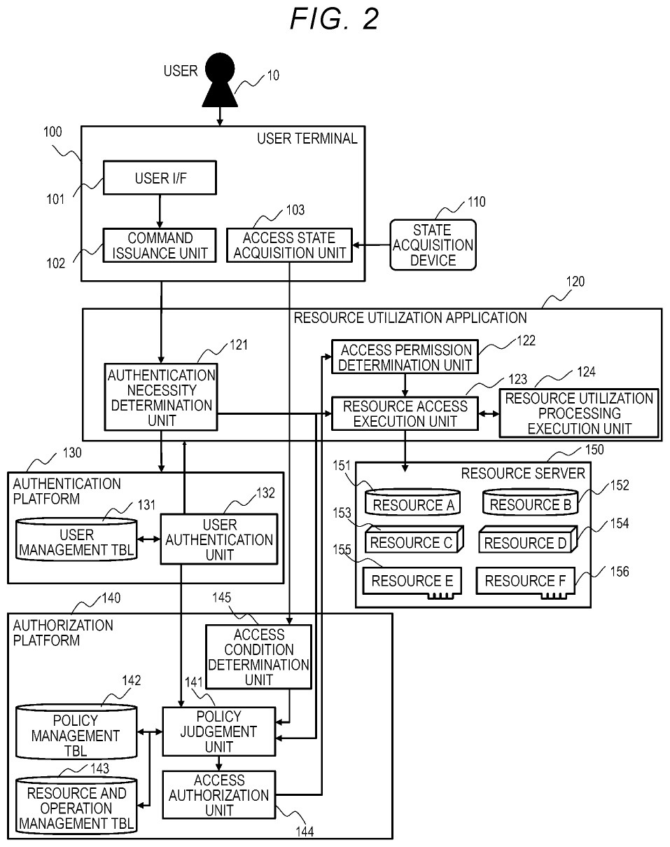

FIG. 2 schematically shows a logical configuration example of a computer system according to an example of the present specification. The computer system includes the resource access authentication and authorization system. The computer system includes a resource utilization application 120, an authentication platform 130, an authorization platform 140, and a resource server 150. These show software components installed in the computer system or functional components, for example, embodied by the processors.

The resource utilization application 120 is included, for example, in the host server 210. The authentication platform 130, the authorization platform 140, and the resource server 150 are included, for example, in the storage system 230.

A user 10 shown in FIG. 2 accesses software resources or hardware resources of the computer system by using the user terminal 100. The user terminal 100 accesses the resource utilization application 120 in response to the input from the user. The user requests resource access by issuing a command of designating a target resource, an operation to the resource, and an operation parameter, to the resource utilization application 120 via the user terminal 100.

The user terminal 100 includes a user interface 101, a command issuance unit 102, and an access state acquisition unit 103. The user interface 101 is a user interface for requesting the execution of the resource operation by the user 10 with the user terminal 100, and, for example, a Web browser can be used as the user interface.

The command issuance unit 102 converts the resource access request input by the user 10 into a command for executing an access destination resource, an operation, and a parameter which can be interpreted by the resource utilization application 120 and issues the command.

The access state acquisition unit 103 acquires the information of a state when the user 10 requests an operation to the resource. The access state includes a state of the user 10 and a state of the user terminal 100. Examples thereof include a network domain (WAN, LAN, Private NW) to which the user terminal 100 is connected, a user terminal type (a desktop PC, a notebook PC, a tablet terminal, a smartphone, a public terminal, and the like), a network security state (a public network, Virtual Private Network (VPN), and the like), access date and time, information acquired by using a state acquisition device 110, and state information input by the user 10.

The state acquisition device 110 is a device connected to the user terminal 100 or built in the user terminal 100. The state acquisition device 110 can include various sensors such as an acceleration sensor, an illuminance sensor, a temperature and humidity sensor, a microphone, and a camera. The state acquisition device 110 acquires user state information. The user state information includes information on the posture and movement of the user 10 and the surrounding environment of the user 10.

The resource utilization application 120 accesses resources such as storages, compute engines (VMs and containers), and networks and executes processes. The resource utilization application 120 includes an authentication necessity determination unit 121, an access permission determination unit 122, a resource access execution unit 123, and a resource utilization process execution unit 124.

When the user 10 requests resource access, the authentication necessity determination unit 121 acquires information for identifying the user, for example, an account name, and determines whether authentication is required or the user is already authenticated. If the user is not authenticated, the authentication necessity determination unit 121 requests the authentication from the authentication platform 130.

The authentication necessity determination unit 121 acquires a command issued by the command issuance unit 102 of the user terminal 100 and sends the command to the resource access execution unit 123 and a policy judgement unit 141 of the authorization platform 140. The sending to the resource access execution unit 123 may be performed after the access to the resource and the execution of the operation are authorized as a result of the determination by the policy judgement unit 141.

The access permission determination unit 122 determines whether the resource access and an operation to the resource which are requested by the user 10 are authorized. When the authorization is completed, the access permission determination unit 122 authorizes the execution of the resource access command to the resource access execution unit 123.

The resource access execution unit 123 issues the resource access command to the resource server 150. The resource utilization process execution unit 124 executes a predetermined process based on the resource access.

The authentication platform 130 receives the authentication request from the resource utilization application 120 and executes the user authentication. The authentication platform 130 includes a user authentication unit 132 and a user management table 131. The user authentication unit 132 processes the sign-in from the user 10. Specifically, the user authentication unit 132 authenticates the identity of the user 10 by using the password input from the user 10 or biometric information such as a fingerprint or the face.

The user management table 131 stores the information of the user registered as the authentication target, such as a user name, attributes, an E-mail address, a password, roles, groups, and access date and time. The user authentication unit 132 performs user authentication by collating input information in case of the sign-in of the user 10 and information stored in the user management table 131.

The authorization platform 140 determines whether the user 10 authenticated in the authentication platform 130 has an access permission to the resource and an execution permission of the operation requested by the user 10. If the user 10 has the access permission and the operation execution permission, the authorization platform 140 performs the authorization, and if the user 10 does not have the access permission and the operation execution permission, the authorization platform 140 does not perform the authorization.

The authorization platform 140 includes the policy judgement unit 141, a policy management table 142, a resource and operation management table 143, an access authorization unit 144, and an access condition determination unit 145. The access condition determination unit 145 determines the condition in case of the access when the user 10 requests the resource access (access condition) from access information field information including the user state information acquired by the access state acquisition unit 103. For example, the access condition is determined based on rules set in advance, from various kinds of data, for example, acquired by the access state acquisition unit 103. Otherwise, the access condition may be determined by an Artificial Intelligence (AI) method or the like using a model generated by machine learning.

The policy judgement unit 141 receives the information of the user authenticated by the user authentication unit 132 and the information of the resource and operation requested for access, from the authentication platform 130 and the resource utilization application 120. The policy judgement unit 141 further acquires the access condition determined by the access condition determination unit 145.

The policy judgement unit 141 collates the resource access policy set in the policy management table 142 in advance and determines whether the user 10 has the access permission to the requested resource and the operation execution permission.

The policy management table 142 stores the information of the access policy (policy information) used by the policy judgement unit 141. The policy defines a judgement rule for the access to the resource and the operation for each resource. The policy management table 142 stores a policy for determining the authorization of the resource access permission and the resource operation execution permission based on the information of the user 10 authenticated by the user authentication unit 132 and the access condition of the user 10 determined by the access condition determination unit 145.

The resource and operation management table 143 stores lists of access target resources and operations of the resource utilization application 120. The policy judgement unit 141 judges whether resources and operations requested for access by the user are valid resources and operations registered in the resource and operation management table 143 and determines authorization of the access permission and the operation execution permission according to the policy.

When it is determined that the authenticated user 10 has an access permission to the requested resource and the execution permission of the request operation as a result of the determination by the policy judgement unit 141, the access authorization unit 144 authorizes an access and an operation to the corresponding resource and sends an authorization code to the resource utilization application 120. When the access is not authorized, the access authorization unit 144 sends a non-authorization message (error code).

The resource server 150 manages resources such as data storages (such as volumes, pools, file directories), compute engines (such as VMs and containers), and networks (such as domains, ports, channels, protocols). The resource server 150 includes one or a plurality of resources.

A resource example A 151 is, for example, a volume of a data storage, and a resource example B 152 is, for example, a file directory of data storage. A resource example C 153 is, for example, a compute virtual machine (VM), and resource example D 154 is, for example, a compute docker container. A resource example E 155 is, for example, a domain of a network resource, and a resource example F 156 is, for example, a port of a network resource.

FIG. 2 shows an example of a flow of authentication, authorization, and resource access processes. The authentication and authorization protocol can be executed, for example, based on standards such as OAuth2, OpenID Connect, SAML. The data including information required for the authentication and authorization (various tokens) is exchanged among the user terminal 100, the resource utilization application 120, the authentication platform 130, and the authorization platform 140, and authentication and authorization processes can be executed while securing security.

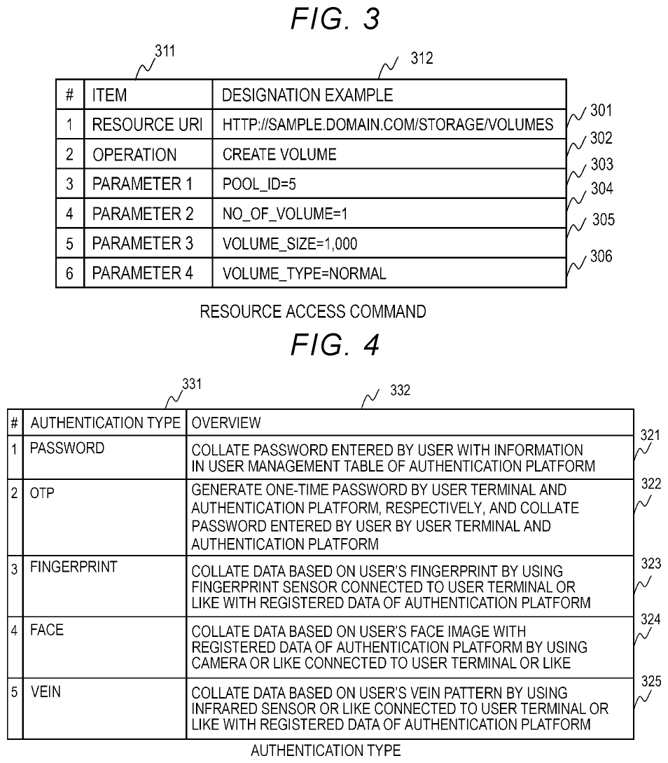

As described above, the user 10 sends a command for a resource access by using the user terminal 100. FIG. 3 shows an example of a resource access command issued by the command issuance unit 102 of the user terminal 100. FIG. 3 shows items 311 of commands and designation examples 312 thereof. In response to this command, the resource access execution unit 123 issues the resource access command to the resource server 150. The resource access command designates a resource of a target, an operation to the resource, a parameter in the operation, and the like.

FIG. 3 shows an example of the storage resource access command. A storage resource access can be executed, for example, by using REST API. The resource of the access target is, for example, a data storage area of a storage system such as a pool or a volume. As described above, the resource accessed and operated is not limited to the storage resource.

A resource Universal Resource Identifier (URI) 301 to be accessed identifies resources and storage locations thereof. The storage resource access command for the resource (the location of the storage volume) designated by the resource URI 301 defines an operation 302 that generates the volume.

The parameter designated for the operation 302 includes a storage pool ID 303 that generates volumes, the number of volumes 304 to be generated, a volume size 305 to be generated, and a parameter 306 of the volumes to be generated. In addition, examples of the operation 302 include volume deletion, volume size change, volume information acquisition, and the like. Examples of the parameter 306 indicating the volume type include a normal volume (for reading and writing data) and a backup volume.

Another example of the resource access is to access a compute resource and create, delete, or modify a virtual machine (VM) or a docker container. Another example of the resource access is to access the network resource, and acquire information of a specific domain or generate a specific network port.

When the user 10 requests the resource access via the user terminal 100, the authentication necessity determination unit 121 in the resource utilization application 120 determines whether the user 10 is already authenticated. When the user 10 is not authenticated, the user authentication is requested from the user authentication unit 132 of the authentication platform 130.

By using a single authentication type or a combination of a plurality of authentication types, the user authentication unit 132 executes the user authentication and determines whether the user is valid. As the authentication method, a well-known method used in various authentication systems can be used. It is also possible to outsource the authentication process to an external authentication system.

FIG. 4 shows an example of an authentication type that can be used by the user authentication unit 132 for the user authentication. FIG. 4 shows an authentication type 331 and an overview 332 thereof. Examples of the authentication type include a password authentication 321, a one-time password authentication 322, a fingerprint authentication 323, a face authentication 324, and a vein authentication 325.

The password authentication 321 collates the password input by the user 10 with the information of the user management table 131 of the authentication platform 130. The one-time password authentication 322 generates a one-time password by the user terminal 100 and the authentication platform 130, respectively, and collates the password input by the user 10 by the user terminal 100 and the authentication platform 130.

The fingerprint authentication 323 collates data based on the fingerprint of the user 10 by using a fingerprint sensor connected to the user terminal 100 or the like with registered data of the user management table 131. The face authentication 324 collates data based on a face image of the user 10 acquired by using a camera or the like connected to the user terminal 100 or the like with registered data of the user management table 131. The vein authentication 325 collates data based on a vein pattern of the user 10 acquired by using an infrared sensor or the like connected to the user terminal 100 or the like with registered data of the user management table 131.

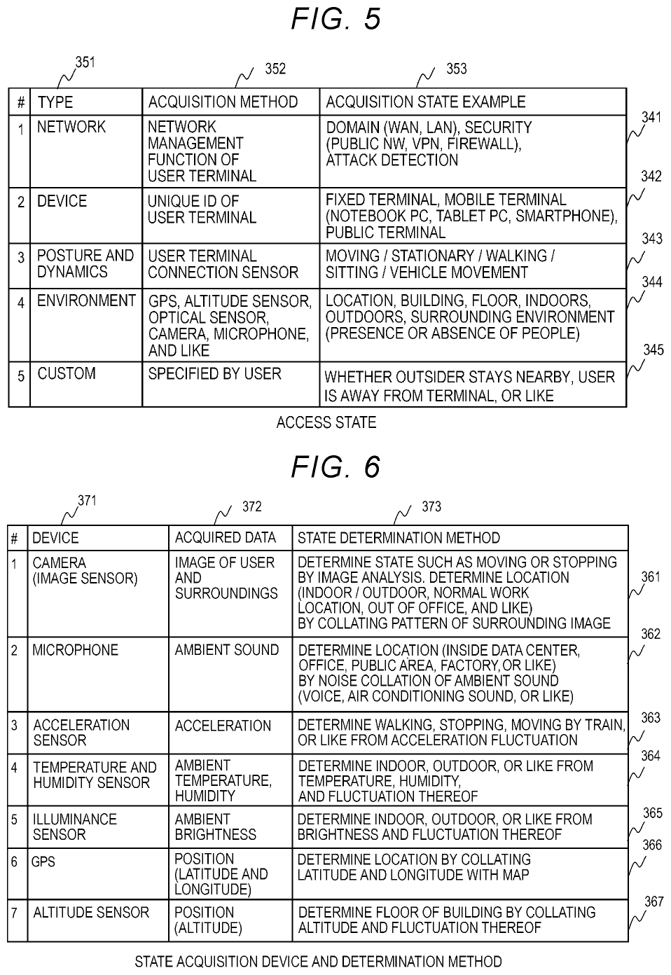

The access state acquisition unit 103 of the user terminal 100 acquires various kinds of information indicating the state of the access of the user. FIG. 5 shows an example of the information acquired by the access state acquisition unit 103. FIG. 5 shows types 351 of information, an acquisition method 352, and an acquisition state example 353 for each type 351.

Examples of the access state information shown in FIG. 5 include network information 341, device information 342, posture and dynamic information 343, environmental information 344, and custom information 345. The network information 341 indicates information relating to the network accessed by the user terminal 100. Examples thereof include information with respect to the network domain (WAN or LAN), the network security (whether the access is from a public network, whether the Virtual Private Network (VPN) is interposed, whether firewall is set, and the like), attack detection via network (whether the connection network includes a packet that indicates a sign of a suspicious attack or the like), and the like. The network information 341 can be acquired by using an existing method based on information used when network management functions of the OS of the user terminal 100 or other programs are based on information used when the network is managed.

The device information 342 indicates information with respect to the types of the user terminal 100. For example, a fixed terminal (connected to a wired network, or the like), a mobile terminal (connected to a wireless network, or the like), or a public terminal (connected to a public network, or the like) is indicated. The device information 342 can be acquired by using an existing method of collating a unique ID (machine addresses, telephone numbers, terminal type identification numbers, and the like) assigned to the user terminal 100 with the terminal type information stored in advance.

The posture and dynamic information 343 indicates the information with respect to the posture and dynamic of the user 10. Examples of the posture and dynamic indicated by the posture and dynamic information 343 include moving, stopping, walking, sitting, or moving by a vehicle. The posture and dynamic information 343 can be determined based on data acquired by the state acquisition device 110, for example, an acceleration sensor connected to or built in the user terminal 100, and the other various sensors.

The environmental information 344 indicates information with respect to the environment where the user 10 is present. The environmental information 344 indicates, for example, information on the position where the user 10 is present, such as a location, a building, and the number of floors, as well as whether the user is present indoors or outdoors, and whether there is a person in the surroundings. The user's position information can be determined based on data acquired by using GPS or an altitude sensor connected to or built in the state acquisition device 110, for example, the user terminal 100.

The indoor or outdoor presence, and the presence or absence of people in the surroundings can be determined based on data acquired by using the state acquisition device 110, for example, a microphone, a camera, or various other sensors connected to or built in the user terminal 100. The indoor or outdoor presence can be also determined from positional information.

The custom information 345 is information set by the user 10. For example, when the user state changes in terms of security due to an external factor such as the presence of an outsider in the vicinity during work or the temporary departure from the user terminal 100, the user 10 inputs the state from the user terminal 100.

In the example shown in FIG. 5, the posture and dynamic information 343 and the environmental information 344 are included in the user state information. The example of the custom information 345 shown in FIG. 5 also includes the user state information. The network information 341 and the device information 342 are included in the attribute information of the user. The role information of the user and the information other than the user state information can be included in the user attribute information. FIG. 5 shows the example of the user state, and a portion thereof may be acquired, and the information of states different from these may be acquired.

As described above, the user state can be determined based on the data acquired by the state acquisition device 110. FIG. 6 shows examples of state acquisition devices that can be used for determining the user state, acquired data, and a method of determining the user state from the acquired data. FIG. 6 shows devices 371 that acquire data targeted by the determination method, acquired data 372, and specific determination methods 353.

In a state determination method 361 using a camera, images of the user 10 and the surroundings thereof are acquired by a camera (image sensor). In the method 361, the dynamics or postures of the user 10 are determined by the image analysis of the user. By the pattern collation of the surrounding image, the location (an indoor or outdoor location, a normal work location, a location out of office, and the like) is determined.

In state determination methods 362 using a microphone, an ambient sound of the user 10 is collected by a microphone. In the method 362, the location where the user 10 is present such as inside the data center, in an office, in a public area, in a factory, or the like is determined by noise collation of the ambient sound (voice, air conditioning sound, or the like).

In a state determination method 363 using an acceleration sensor, the acceleration of the user terminal 100 and the user 10 who possesses the user terminal are acquired by the acceleration sensor. In the method 363, walking, stopping, moving by a train, or the like of the user 10 is determined from the acceleration fluctuation.

In a state determination method 364 using a temperature and humidity sensor, the temperature and the humidity of the surrounding of the user 10 are acquired by the temperature and humidity sensor. In the method 364, indoor and outdoor locations and the like are determined from the temperature, humidity, and fluctuation thereof. In a state determination method 365 using an illuminance sensor, data of brightness of the surroundings of the user 10 is acquired by the illuminance sensor. In the method 365, indoor and outdoor locations and the like are determined from the brightness and fluctuation thereof.

In a state determination method 366 using GPS, the position (latitude and longitude) of the user 10 is acquired by the GPS. In the method 366, the location is determined by collating the longitude and latitude with a map. In a state determination method 367 using an altitude sensor, the position (altitude) of the user 10 is acquired by the altitude sensor. In the method 367, the floor of the building where the user 10 is present is determined from the location information by GPS, the altitude, the fluctuation thereof, the atmospheric pressure information in the vicinity, and the like.

As described above, the access state acquisition unit 103 acquires (determines) the user state as shown in “acquisition state example” of the access state of FIG. 5 by applying a well-known analysis method shown in the acquisition method to data acquired by using various devices. The user state includes the posture, the dynamic, the position, and the surrounding environment of the user.

The method of determining the user state may be based on a rule generated based on a heuristic method from the combination of data from a sensor or the like. In another example, an AI technology may be used. For example, the state when the user actually accesses the resource is set as a teacher, data acquired by the sensor or the like at that time may be used for the learning data, to generate a determination model by a method such as machine learning or regression analysis.

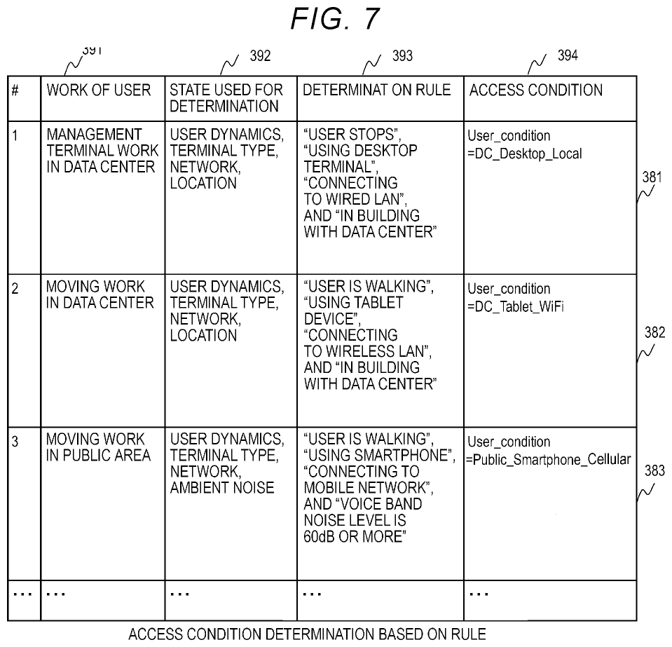

As described above, the access condition determination unit 145 of the authorization platform 140 determines the condition in case of the resource access (access condition) based on the access state information sent from the user terminal 100. FIG. 7 shows an example of an access condition determination method. In the example shown in FIG. 7, the access condition is determined from the access state of the user according to the determination rule set in advance.

The access condition determination unit 145 determines the access condition based on the state information described with reference to FIGS. 5 and 6. Specifically, a network state, a terminal state, a user state (including a state of the user and the environment thereof), and a custom state can be included.

FIG. 7 shows, for example, three determination rules 341 to 343, and shows works 391 of the user determined from the access states, state 392 used for determination, specific contents 393 of the determination rules, and access conditions 394 of the determination results.

In a determination rule 381, when the user stops, a desktop terminal is used, a user terminal is connected to the wired LAN, and the user is in a building with a data center, it is determined that the access condition is the management terminal work in the data center. The access condition is represented as “User_condition=DC_Desktop_Local”.

In a determination rule 382, when the user walks, a tablet terminal is used, a user terminal is connected to wireless LAN, and the user is in a building with a user data center, it is determined that the access condition is the moving work in the data center. The access condition is represented as “User_condition=DC_Tablet_WiFi”.

In a determination rule 383, when the user walks, a smartphone is used, the user terminal is connected to a mobile network, and a voice band noise level is 60 dB or more, it is determined that the access condition is the moving work of the public area. The access condition is represented as “User_condition=Public_Smartphone_Cellular”.

The determination rule can be generated based on a heuristic method with respect to a combination of access states by users. In addition, the access condition when the user actually accesses the resource may be set as a teacher, and a method such as machine learning or regression analysis may be performed as learning data of the user state at that time, a determination model may be generated.

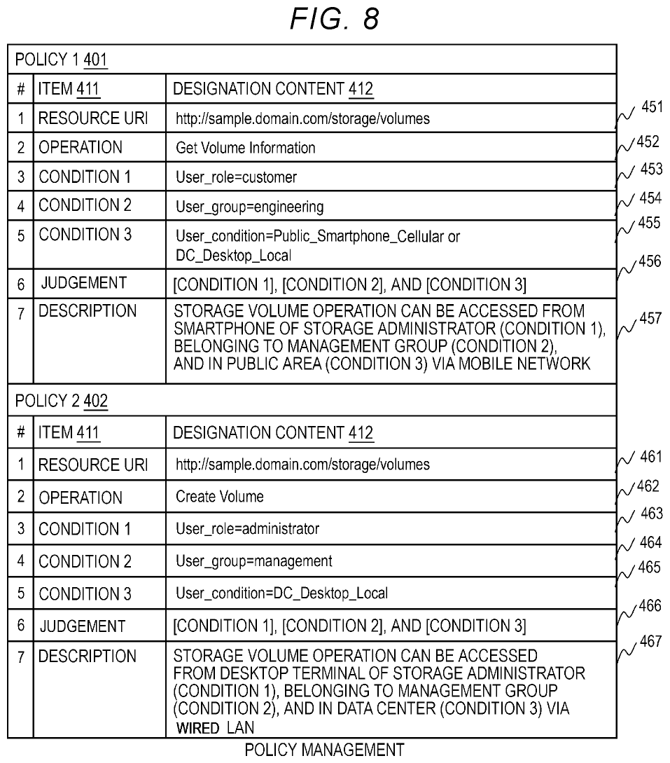

As described above, the policy judgement unit 141 determines whether the resource and the operation requested for access by the user are a valid resource and a valid operation registered in the resource and operation management table 143, the authorization of the access permission and the operation execution permission is determined according to the policy. FIG. 8 shows examples of policies using the resource access condition of the user. FIG. 8 shows two policies 401 and 402, for example. Each policy indicates an item 411 and a designation content 412 of each item 411.

As shown in a description item 457, in the policy 1 (401), the storage volume operation requires a storage manager (Condition 1), an affiliation of a management group (Condition 2), and access from a smartphone in a public area via a mobile network (Condition 3). The policy 1 (401) shows a determination target resource URI 451, a determination target operation 452, authorization conditions 453 to 455, and an authorization determination request condition 456.

That is, the policy 1 (401) authorizes the designated command (Get Volume Information) 452 when all of the three conditions 453 to 455 are satisfied for the designated resource 451. Three conditions are as follows. In the condition 1 (453), the role of the user is a customer. In the condition (454), the user belongs to an engineering group. In the condition 3 (455), the access condition of the user is “Public_Smartphone_Cellular or DC_Desktop_Local” (the user performs access from a smartphone in a public area via a mobile network or from a desktop terminal in the data center via wired LAN).

In the policy 2 (402), as shown in a description item 467, the storage volume operation requires a storage manager (Condition 1), an affiliation of a management group (Condition 2), and access from a desktop terminal in the data center via wired LAN. The policy 2 (402) shows a determination target resource URI 461, a determination target operation 462, authorization conditions 463 to 465, and an authorization determination request condition 466.

That is, the policy 2 (402) authorizes the designated command (Create Volume) 462 when all of the three conditions 463 to 465 are satisfied for the designated resource 461. The three conditions are as follows. In the condition 1 (463), the role of the user is an administrator. In the condition (464), the user belongs to a management group. In the condition 3 (465), the access condition of the user is “DC_Desktop_Local” (the user is connected from a desktop terminal of the data center via wired LAN).

For example, it is assumed that roles of a customer and an administrator are assigned to a certain user, and the user belongs to two groups of the engineer and the management. It is assumed that the access condition of the corresponding user is wired LAN connection (DC_Desktop_Local) from a desktop terminal in the data center.

If the execution of a command (Get Volume Information) that is an authorization target by the policy 1 (401) with respect to the resource URI (http://sample.domain.com/storage/volumes) is requested, the execution of the command is authorized to the user. In the same manner, if the execution of a command (Create Volume) that is an authorization target by the policy 2 is requested, the execution of the command is authorized to the user.

In another example, it is assumed that the access condition of the corresponding user is mobile network connection (Public_Smartphone_Cellular) from a smartphone in a public area. If the execution of a command (Get Volume Information) that is an authorization target by the policy 1 (401) is requested, the execution is authorized. However, if the execution of a command (Create Volume) that is an authorization target by the policy 2 (402) is requested, the execution is not authorized, since the access condition does not satisfy the determination requirement.

In this manner, in addition to the role and the affiliation group of the user, the condition in case of the access is used for the policy judgement. Accordingly, when the same user has a plurality of roles and/or belongs to a plurality of groups, and a different resource access and different command execution are requested, the authorization can be performed only when the user requests the execution based on valid access conditions. In addition, the policies shown in FIG. 8 are examples, and a portion of the exemplified conditions or a different condition may be requested. For example, the role and the affiliation group of the user may not be included.

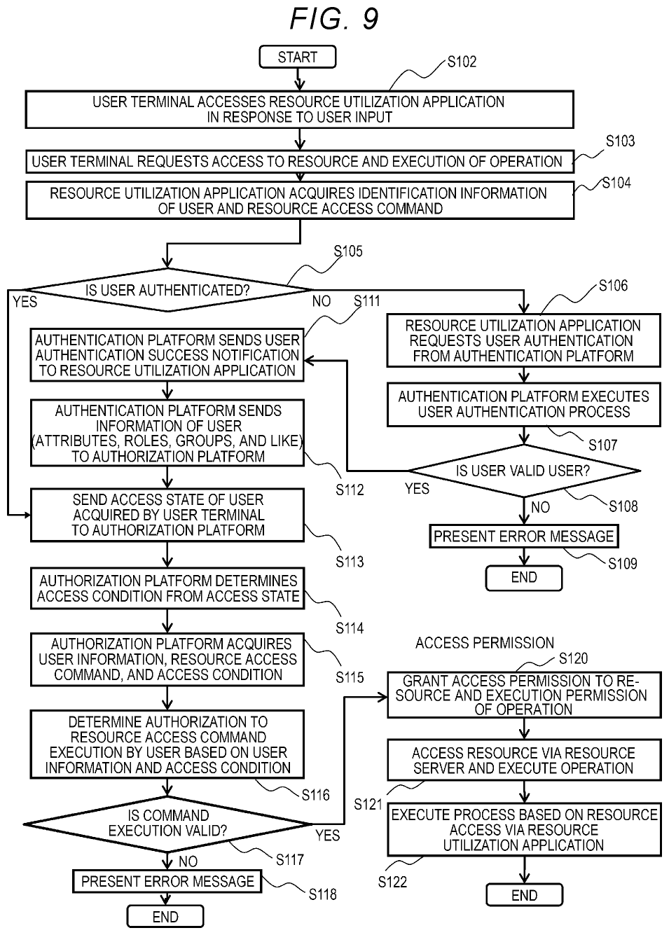

FIG. 9 shows an example of a processing flow of the resource access authentication and authorization system based on the user access condition. First, the user terminal 100 accesses the resource utilization application 120 in response to the instruction from the user 10 (S102). The command issuance unit 102 of the user terminal 100 requests access to a specific resource and execution of an operation for the resource utilization application 120 in response to the user input (S103).

The resource utilization application 120 acquires the identification information of the user and the resource access command from the user terminal 100 (S104). The authentication necessity determination unit 121 refers to management information showing authenticated users and determines whether the user authentication of the corresponding user 10 is completed (S105).

When the user authentication is not completed (No in S105), the authentication necessity determination unit 121 requests the user authentication for the authentication platform 130 (S106). The user authentication unit 132 of the authentication platform 130 acquires information required for the user authentication from the authentication necessity determination unit 121, refers to the user management table 131, and executes the user authentication (S107).

When the user is not a valid user (No in S108), the authentication necessity determination unit 121 acquires the determination result from the user authentication unit 132 and sends an error message to the user terminal 100. The user terminal 100 presents the error message to the user 10 (S109). As an error process, the application may be closed, an access from the user to an application may be blocked, or the authentication process may be re-executed by promoting a user to input a new password.

When the user is a valid user (Yes in S108), the authentication necessity determination unit 121 notifies user authentication success notification to the resource utilization application 120 (S111). The authentication necessity determination unit 121 sends user information (such as an attribute, a role, and a group) to the authorization platform 140 (S112).

After Step S112 or in Step S105, when the user authentication is completed (Yes in S105), the access state acquisition unit 103 of the user terminal 100 sends the information of the access state obtained from the state acquisition device 110 and the other resources to the authorization platform 140 via the resource utilization application 120 (S113). The access state may be sent, for example, in response to the reception of the notification that the user is authenticated as valid by the user terminal 100.

As described above, once the user authentication is executed, the user authentication thereafter is omitted. Accordingly, the authentication is not required for each time of the access to the resource, and the access to the plurality of resources with authentication of one time can be authorized. The user authentication may be performed for each access request. The authentication may be performed in conformity with the authentication and authorization protocol such as OpenID Connect or SAML. In such a protocol, identification information referred to as a token is issued in case of the authentication success, and whether the user is authenticated is determined based on the validity determination of the token.

Subsequently, the access condition determination unit 145 of the authorization platform 140 determines the access condition from the information of the received access state (S114). The policy judgement unit 141 of the authorization platform 140 acquires the user information, the resource access command, and the access condition (S115). The policy judgement unit 141 determines the authorization of the execution of the resource access command by the user 10 based on the user information and the access condition (S116).

When it can be determined that the access conditions when a plurality of resource access requests are generated are not changed, such as when a plurality of times of resource access is requested in a short time, with respect to the authentication of one time, the access condition determination (S114) is omitted from the authorization determination flow (S113 to S115) for the resource access requests of the second and subsequent times, and the access conditions acquired the first time may be used for the second and subsequent times.

When the determination result shows that the command execution is invalid (No in S117), the access authorization unit 144 sends the error message to the user terminal 100 via the resource utilization application 120, and the user terminal 100 presents the error message to the user 10 (S118). As the error process, the application may be closed, or the access to the application from the user may be blocked, and the authorization process may be re-executed by promoting a user to input a new resource access command.

When the determination result shows that the command execution is valid (Yes in S117), the access authorization unit 144 sends the command execution authorization notification to the access permission determination unit 122 of the resource utilization application 120. The access permission determination unit 122 responds to the authorization notification and grants the user 10 the access permission to the resource and the execution permission of the operation (S120).

The resource access execution unit 123 accesses the resource via the resource server 150 and executes the operation (S121). The resource utilization process execution unit 124 executes a process based on the resource access (S122). The process completion notification is sent from the resource utilization application 120 to the user terminal 100.

### EXAMPLE 2

In the above configuration example, whether to authorize the resource operation by the user is determined. In the configuration example described below, in addition to the operation of the resource, the authorization to the parameter of the operation is determined. Accordingly, in the same manner as the operation of the storage resource, also with respect to an operation of also designating a control parameter (such as the size and the RW permission), fine access control including the control parameter can be performed.

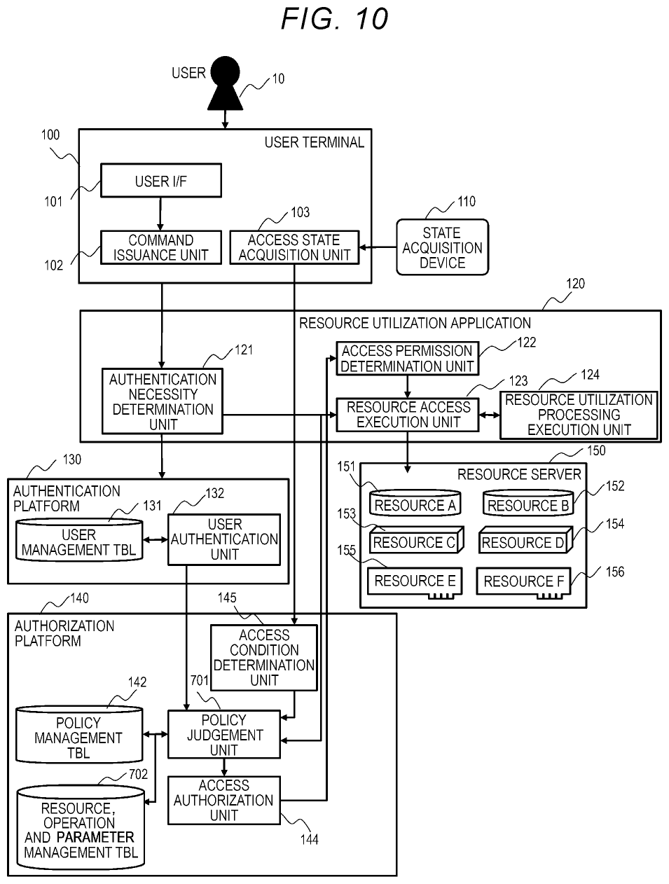

FIG. 10 shows a configuration example when a resource operation parameter is authorized in the authentication and authorization system. Hereinafter, differences from the configuration example shown in FIG. 2 are mainly described. In the configuration example shown in FIG. 10, in the resource access authentication and authorization system shown in FIG. 2, an operation parameter is set to a target of an authorization process. The system includes a policy judgement unit 701 and a resource, operation, and parameter management table 702 instead of the policy judgement unit 141 and the resource and operation management table 143.

The policy judgement unit 701 receives information of the user 10 authenticated by the user authentication unit 132, a resource requested for access, an operation to the resource, and information of a parameter of an operation from the authentication platform 130 and the resource utilization application 120. The policy judgement unit 701 further acquires the access condition determined by the access condition determination unit 145. The policy judgement unit 701 collates these with the resource access policy set in advance in the policy management table 142 and determines whether the user 10 has the access permission to the requested resource and execution permissions to the operation to the resource and the parameter designated in case of the operation.

The resource, operation, and parameter management table 702 stores a list of combinations of operations to resources and parameters in case of the operations in addition to the access target resources of the resource utilization application 120. The policy judgement unit 701 determines whether a resource, an operation, and a parameter that are requested for access by the user are a valid resource, a valid operation, and a valid parameter registered in the resource, operation, and parameter management table 702, and determines authorization of an access permission, an operation execution permission, and a parameter setting permission according to a policy.

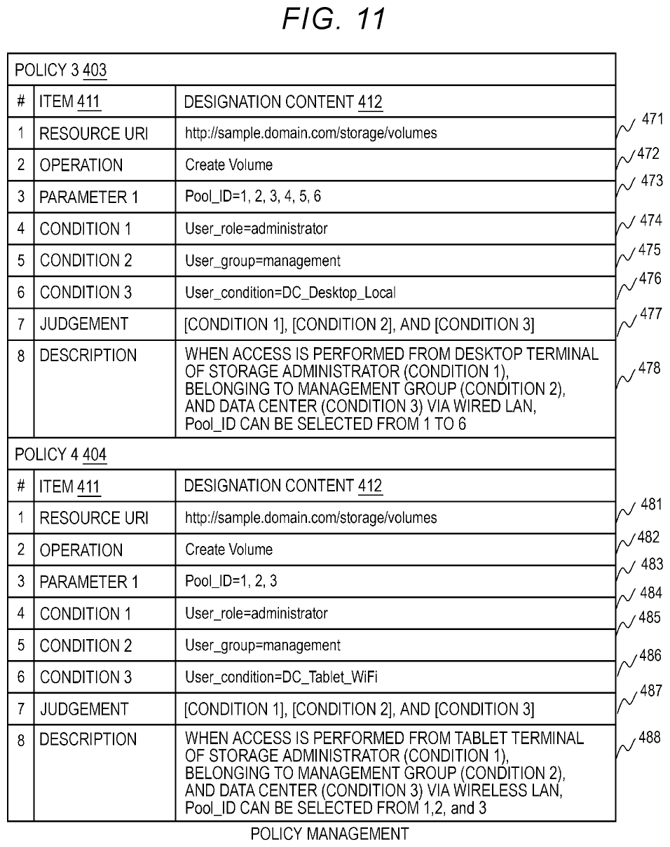

FIG. 11 shows examples of policies for authorization determine of resource operation parameters. As shown in a description item 478, when the user is a storage manager (Condition 1), belongs to a management group (Condition 2), and further performs access from a desktop terminal in the data center via wired LAN, the policy 3 (403) defines that Pool ID can be selected from 1 to 6.

That is, when all of three conditions 474 to 476 are satisfied, the policy 3 (403) authorizes a setting of designated parameters (Pool_ID=1,2,3,4,5,6) 473 for a designated command (Create Volume) 472 to a designated resource 471.

Three conditions are as follows. In a condition 1 (474), the role of the user is an administrator. In a condition 2 (475), the user belongs to a management group. In a condition 3 (476), the access condition of the user is “DC_Desktop_Local” (the user performs access from a desktop terminal in the data center via wired LAN).

As shown in a description item 488, a policy 4 (404) defines that Pool ID can be selected from 1, 2, and 3, in case of a storage manager (Condition 1), an affiliation of a management group (Condition 2), and access from a tablet terminal in the data center via wireless LAN.

That is, when all of three conditions 484 to 486 are satisfied, the policy 4 (404) authorizes the setting of a designated parameter (Pool_ID=1,2,3) 483 for a designated command (Create Volume) 482 to a designated resource 481.

The three conditions are as follows. In the condition (484), a role of the user is an administrator. In the condition 2 (485), the user belongs to a management group. In the condition 3 (486), the access condition of the user is “DC_Tablet_WiFi” (the user is connected from a tablet terminal of the data center via wireless LAN).

For example, it is assumed that a role of an administrator is assigned to a certain user, the user belongs to a management group, and the access condition of the corresponding user is access by wired LAN connection from a desktop terminal in the data center. At this point, the storage pool that can generate volumes can be selected from storage pools of which IDs are 1 to 6.

Meanwhile, when the user performs access by wireless LAN connection from a tablet terminal in the data center, the storage pool that can generate volumes can be selected only from storage pools of which IDs are 1 to 3.

When the storage pool has different security levels according to the type, in case of the wired LAN connection from the desktop terminal in the data center, the volumes can be generated by access to IDs (4, 5, and 6) which request a high security level. However, also in the same data center, when a maintenance work is performed by using a tablet terminal while moving, and wireless LAN is used for the communication, the risk of communication interception is higher than in the case of the wired connection. Therefore, only access to storage pools (ID=1, 2, 3) of which security level is lower, and only the volume generation work is authorized.

In this manner, in the present example, even if the user is the same, according to the condition in case of the resource access, the resource operation execution permission in the designated parameter can be controlled by the policy. Accordingly, superfine management can be performed on the access and the operation to the resource that requires a fine parameter setting such as a storage.

The parameter that can be a target of the access control can include a parity group ID, drive location ID, LUN ID, volume capacity, port type (such as Fibre Channel and iSCSI), a port ID, a size, and the like such as the pool ID. In the system different from the storage system, an arbitrary parameter different from these can be designated.

The present invention is not limited to the above embodiments and includes various modifications. For example, the above embodiment is described in detail in order to explain the present invention for easier understanding, and is not limited to the one necessarily including all the configurations described. Further, a part of a configuration of one embodiment can be replaced with a configuration of another embodiment, and a configuration of another embodiment can be added to a configuration of one embodiment. Addition, deletion, and replacement of another configuration can be made with respect to a part of a configuration of each embodiment.

Each of the above configurations, functions, processing units, and the like may be embodied by hardware, for example, by designing a part or all thereof with an integrated circuit. Each of the above configurations, functions, and the like may be embodied by software by a processor interpreting and executing a program that embodies each function. Information such as programs, tables, and files that embody each function can be placed in a memory, a hard disk, a recording device such as a Solid State Drive (SSD), or a recording medium such as an IC card or an SD card.

Control lines and information lines indicate what is considered necessary for explanation, and not all control lines and information lines on the product are necessarily shown. In practice, it can be considered that almost all configurations are interconnected.

What is claimed is:

1. A system that controls access to a resource by a user, the system comprising:
one or more processors; and
one or more storage devices that store policy information for determining a condition with respect to an operation of the resource,
wherein the one or more processors
acquire a first access request that shows a predetermined operation to a first resource by the user from a user terminal,
acquire user state information that shows a current state of the user from the user terminal,
determine a condition in case of access by the user based on the user state information, and
determine whether to authorize the first access request based on the policy information and the condition in case of the access.

2. The system according to claim 1,
wherein the user state information shows at least one of a posture and a dynamic of the user.

3. The system according to claim 1,
wherein the one or more processors
acquire information of the user from the user terminal, and
determine the condition in case of access by the user based on the user state information and information of the user terminal.

4. The system according to claim 1,
wherein the one or more processors
acquire information of a network to which the user terminal is connected, and
determine the condition in case of access by the user based on the user state information and information of the network.

5. The system according to claim 1,
wherein the first access request further includes a designated parameter of the predetermined operation, and
the policy information shows a parameter that can designate the predetermined operation of the first resource.

6. The system according to claim 1,
wherein a condition to the first access request shown by the policy information includes a role of the user, and
the one or more processors determine a role of the user based on information of the user acquired from the user terminal in an authentication process of the user.

7. The system according to claim 1,
wherein the one or more processors
execute user authentication of the user before determining whether to authorize the first access request, and
determine whether to authorize the access request from the user after the first access request without the user authentication of the user.

8. The system according to claim 1,
wherein the resource is a data storage area of a storage system.

9. The system according to claim 1,
wherein the user terminal generates the user state information based on data measured by a sensor.

10. A method of controlling access to a resource by a user by a system, the method comprising:
storing policy information for determining a condition with respect to an operation of the resource by the system;
acquiring a first access request that shows a predetermined operation to a first resource by the user from a user terminal by the system;
acquiring user state information that shows a current state of the user from the user terminal by the system;
determining a condition in case of access by the user based on the user state information by the system; and
determining whether to authorize the first access request based on the policy information and the condition in case of the access by the system.
